(19) United States
(12) Patent Application Publication
(10) Pub. No.: US 2003/0125828 A1
(43) Pub. Date: Jul. 3, 2003

(54) SmartPath: an intelligent tool path optimizer that automatically adusts feedrates, accel rates and decel rates based on a set of rules and spindle torque defined by the user

(76) Inventor: Gary John Corey, Wildomar, CA (US)

Correspondence Address: Mr. Gary John Corey, 21445 Bundy Canyon Road, Wildomar, CA, 92595, US

(21) Appl. No.: 10/036,174

(22) Filed: Jan. 3, 2002

(51) Int. Cl. G06F 19/00

(52) U.S. Cl. 700/186; 700/173

(57) ABSTRACT

SmartPath provides CNC machinists using CNC Controllers a database of cutting methods, which will be automatically applied when the CNC Controller anticipates the upcoming scenario. SmartPath acts as a database collecting information about the machine's stresses and the machine's ability to cut a part. The CNC Controller in real time gathers this information as the machine moves and then automatically adds the information to the database. SmartPath is a form of artificial intelligent learning gathering its knowledge from the feedback of the CNC machine controller as it cuts. The operator can insert and override any of the cutting methods or scenarios.

### CROSS-REFERENCE TO RELATED APPLICATIONS:

Not Applicable

### STATEMENT REGARDING FEDERALLY SPONSORED RESEARCH OR DEVELOPMENT:

Not Applicable

### REFERENCE TO A COMPUTER PROGRAM LISTING COMPACT DISK APPENDIX

The Appendix contains two copies on compact disk of the entire SmartPath computer program listing in standard ASCII character file format. Each compact disk contains the same single file entitled SMARTPATH.TXT.

### BACKGROUND OF THE INVENTION

SmartPath has been invented for the high-speed Computer Numerical Control (CNC) machining industry. Prior to the invention of SmartPath, tool path optimization was performed manually and had to be manually re-entered each time a part was cut. With SmartPath, the user now has the ability to store basic cutting parameters and then recall them. By filling in the SmartPath computer screen, the computer now has the information it needs to automatically create an intelligent tool path optimization sequence that automatically adjusts feedrates, accel rates and decel rates based on a set of rules and spindle torque.

Below are 25 references to specific documents and articles related to my invention.

[1] Altintas, Y., 1994, “A Hierarchical Open-Architecture CNC System for Machine Tools”, Annals of the CIRP, vol. 43, pp. 349-354.

[2] Altintas, Y., 2000, Manufacturing Automation: metal cutting mechanics, machine tool vibrations, and CNC design, Cambridge University Press, ISBN 0-521-65973-6.

[3] Choi, B and R. Jerard, 1998, Sculptured Surface Machining—Theory and Applications, Kluwer Academic Publishers, ISBN 0-412-78020-8

[4] Drysdale, R. L., R. B. Jerard, B. Schaudt and K. Hauck, “Discrete Simulation of NC Machining,” Algorithmica Special Issue on Computational Geometry, 4, (1), pp. 33-60, 1989.

[5] Fussell, B. K. and K. Srinivasan, “An Investigation of the End Milling Process Under Varying Machining Conditions”, Transactions of the ASME, Journal of Engineering for Industry, Vol. 1, pp. 27-36, January 1989.

[6] Fussell, B. K., R. B. Jerard and O. K. Durdag, “Geometric and Mechanistic Model Integration for 3-Axis CNC Feedrate Generation,” ASME Winter Annual Meeting, San Francisco, December 1995.

[7] Fussell, B. K. R. B. Jerard and J. G. Hemmett, “CNC Feed Velocity Selection for Sculptured Surface Machining,“Proceedings of the 2000 NSF Design and Manufacturing System Conference,” Vancouver, B.C., Canada, January 3-6.

[8] Fussell, B. K., R. B. Jerard and J. G. Hemmett, “Robust Feedrate Selection for 3-axis Machining Using Discrete Models,” ASME Journal of Manufacturing Science and Engineering, in press.

[9] Hemmett, J. G., B. K. Fussell and R. B. Jerard, “A Robust and Efficient Approach to Feedrate Selection for 3-axis Machining,” Dynamics and Control of Material Removal Processes, 2000 ASME International Mechanical Engineering Congress, November 5-10, Orlando, Fla. [10] Hemmett, J. G. B. K. Fussell, and R. B. Jerard, “Automatic 5-axis CNC feed-rate selection via discrete mechanistic, geometric and machine model integration,” Proceedings of the IFIP TC5 WG5.3 Conference on Sculptured Surface Machining, Kluwer Academic Publishers, 1999.

[11] Jerard, R. B., R. L. Drysdale, B. Schaudt, K. Hauck and J. Magewick, “Methods for Detecting Errors in Sculptured Surface Machining,” IEEE Computer Graphics and Applications, January 1989, pp. 26-39.

[12] Jerard, R. B., B. K. Fussell, J. G. Hemmett, Mustafa T. Ercan, “Toolpath Feedrate Optimization: A Case Study,” Proceedings of the 2000 NSF Design and Manufacturing System Conference,“Vancouver, B.C., Canada, January 3-6.

[13] Jerard, R. B., Barry K. Fussell, Mustafa T. Ercan, Jeffrey G. Hemmett, 2000,“Integration of Geometric and Mechanistic Models of NC Machining into an Open-Architecture Machine Tool Controller”, ASME International Mechanical Engineering Congress and Exposition November 5-10, Walt Disney World, Dolphin, Orlando, Fla.

[14] Kline, W. A., R. E. DeVor and J. R. Lindberg, “The Prediction of Cutting forces in End Milling with Application to Cornering Cuts,” International Journal of Machine Tool Design and Research, Vol. 22, no. 1, pp. 7-22, Pergamon Press, 1982.

[15] Kline, W. A. and R. E. DeVor, “The Effect of Runout on cutting Geometry and Forces in End Milling,” International Journal of Machine Tool Design and Research, Vol. 23, pp. 123-140, Pergamon Press, 1983.

[16] Machining Data Handbook, 2nd Ed. Metcut, Research Associates, 1972.

[17 ] 2001 NSF Design, Manufacturing & Industrial Innovation Research Conference, Jan. 7-10, 2001, Tampa, Fla.

[18] Ryou, O. and R. B. Jerard, 2001, “NCML: An Internet Compatible Data Exchange Format for Custom Machined Parts,” Proceedings of the 2001 NSF Design, Manufacturing & Industrial Innovation, Research Conference, January 7-10, Tampa, Fla.

[19] Spence, A. D. and Altintas, Y., 1994, “A Solid Modeler Based Milling Process Simulation and Planning System,” Transactions of the ASME Journal of Engineering for Industry, vol. 116, pp. 61-69.

[20] Taylor, F. W., 1947 Scientific Management, Harper & Brothers, New York.

[21] Tlusty, J. and P. MacNeil, “Dynamics of Cutting Forces in End Milling,” Annals of the CIRP, Vol. 24/1, 1975.

[22] Tlusty, J. and Smith, S., 1985, “Force Vibration, chatter, accuracy in high speed milling,” Proceedings of the 13^{th} North American Manufacturing Research Conference, Berkeley, Calif. 221-9 May.

[23] Vericut Optipath Software, CGTech Corporation, http://www.cgtech.com

[24] Yang, M. Y. and H. Park, “The Prediction of Cutting Force in Ball—End Milling,” International Journal of Tools Manufacturing, Vol. 31, No. 1, pp 45-51, 1991.

[25] Yang, M. Y. and C. G. Sim, “Reduction of Machining Errors by Adjustment of Feedrates in the Ball-End Milling Process,” International Journal of Production Research, Vol. 31, No. 3, pp 665-689, 1993.

### BRIEF SUMMARY OF THE INVENTION

The object of SmartPath is to provide CNC machinists using CNC Controllers a database of cutting methods, which will be automatically applied when the CNC Controller anticipates the upcoming scenario. The program acts as a database collecting information about the machine's stresses and the machine's ability to cut a part. The CNC Controller in real time gathers this information as the machine moves and then automatically adds the information to the database. SmartPath is a form of artificial intelligent learning gathering its knowledge from the feedback of the CNC machine controller as it cuts. The operator can insert and override any of the cutting methods or scenarios.

### BRIEF DESCRIPTION OF THE SMARTPATH COMPUTER SCREEN DRAWING

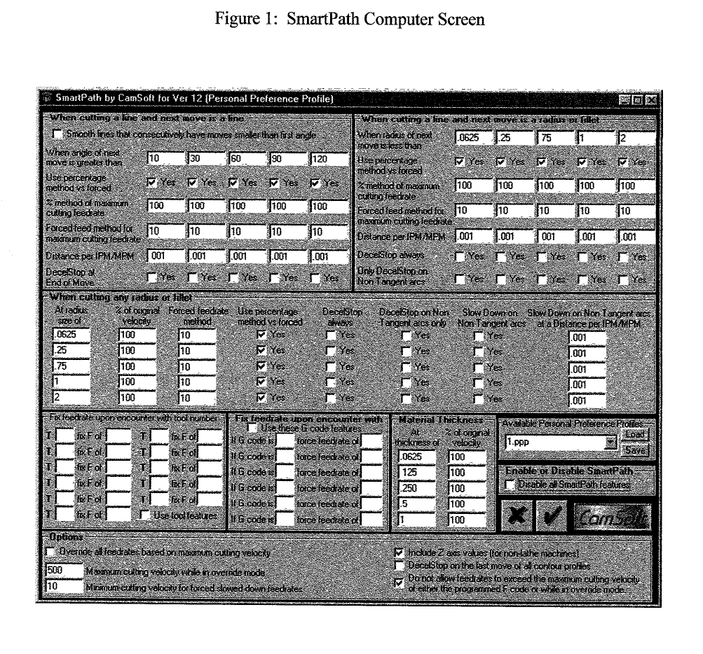

SmartPath consists of a single computer screen that must be filled in by the user to enable SmartPath to automatically adjust feedrates, accel rates and decel rates based on a set of rules and spindle torque. A hard copy of the SmartPath's computer screen is contained in the DRAWINGS section and is referred to as FIG. 1.

### DETAILED DESCRIPTION OF THE INVENTION

SmartPath is an intelligent tool path optimizer computer program that automatically adjusts feedrates, accel rates and decel rates based on a set of rules and spindle torque defined by the user and was invented to simultaneously increase the accuracy, quality and quantity of part cutting in the CNC machining industry. SmartPath was developed using Microsoft's Visual Basic and the Assembler programming languages.

SmartPath automatically pre-processes original G code while the machine tool is loading it into memory. The end result is an optimized G code program ready to run based on the rules and options selected on the SmartPath setup screen. There are over 175 easy-to-use settings and parameters on a single computer screen to configure a user's preferences with fill-in-the-blank values or check boxes. No extra programming is necessary by the user. SmartPath is easy to configure and once set up for a particular application, does not need any further user input.

Efficiency and cut quality are readily noticed. The finish is always better, the corners are always sharper and by automatically reducing the feedrate or velocity at just the right time, the machine runs smoother without any jerky motions and overall stress caused by sudden change of directions. Using SmartPath in conjunction with the Dynamic Feedrate feature on a mill or router enables the machine to automatically sense when the spindle loads up so the feedrate can be automatically decreased or increased every 60 milliseconds. As the machine turns a sharp corner, the velocity is decelerated into the corner and then accelerated out smoothly. When a spline is detected, a special algorithm goes into effect creating a very smooth finish. Users may create a library of personal preference profiles of cutting rules for each material or part thickness for others to use. Over 80 personal preference profiles can be saved to recall different cutting conditions of materials, vendors, machine types or user preferences. Checking off the “Override all feedrates based on maximum cutting velocity” box will allow the machine to always cut as fast as it can regardless of the complexity of the geometry or material being cut since SmartPath automatically sets and adjusts the feedrates based on each cutting situation.

To use SmartPath, users input specific information into an easy-to-use, fill-in-the-blank screen. Refer to the DRAWINGS section of this patent application for a printout of the SmartPath computer screen. The specific information users must input into the SmartPath screen to generate an intelligent tool path optimization scheme is described below.

Feature Explanation of the SmartPath Computer Screen

(Enable or Disable SmartPath)

This box enables or disables all of the SmartPath features.

(Available Personal Preference Profiles)

These are files that contain all the settings the user entered in the SmartPath screen. Users may save and load their own personal preference favorite settings. To create a new personal preference profile, users need to clear the existing entry in the yellow drop down combo box and enter in a new filename and then click on the SAVE button.

(Override all Feedrates Based on Maximum Cutting Velocity) and (Maximum Cutting Velocity While in Override Mode)

These two settings work together to override all the feedrates in the user's G code program. The idea is to set a feedrate at which the machine could easily cut at under normal conditions, as fast as possible, and allow SmartPath to automatically decrease or increase the feedrates as needed based on the rules the user set up.

(DecelStop on the Last Move of All Contours Profiles)

When this box is checked, a decelerated stop G code will be inserted on any G1, G2, G3 that is the last move of a contour or profile. The last move is defined as any G1, G2, G3 move that detects the next G code line ahead of it as a non-move line.

(Minimum Cutting Velocity for Forced Slowed Down Feedrates)

This is the feedrate that will be used if the newly calculated feedrate falls below this value.

(Material Thickness)

The idea behind these settings are based upon all entered and calculated feedrates using the following formula: New Feedrate=F code times (% of original velocity) whenever the part thickness falls between the ranges of (At thickness of). A value of 0 disables these features. The only exceptions are feedrates forced with (Forced feed method for maximum cutting feedrate) or fall below the value entered into (Minimum cutting velocity for forced slowed down feedrates). A new feedrate will be calculated whenever the part thickness is greater than zero to the value in the first box and then between the first and second box and so on. If a part thickness was never entered, then the settings in this group have no effect.

(When Cutting a Line and Next Move is a Line)

This group of settings only goes into effect when the current move is a line and the next move is also a line. The (Use percentage method vs. forced) box allows the user to toggle between two alternate feedrate calculation methods. The percentage method multiplies the original programmed feedrate by the percentage value the user entered into the (% method of maximum cutting feedrate) box whenever the included angle between the current move and next move falls between the boxes labeled (When angle of next move is greater than). The included angle is measured by subtracting the angle direction of the next move from the angle direction of the current move. The straighter the line, the closer the included angle is to zero. Always enter the angles from smallest to largest, from left to right, into the (When angle of next move is greater than) boxes. The (Forced feed method for maximum cutting feedrate) method inserts a predetermined feedrate instead of calculating the feedrate based on percentage. Setting the (% method of maximum cutting feedrate), (Distance per IPM/MPM) or (Forced feed method for maximum cutting feedrate) to 0 disables these features. The distance at which the slow down occurs is at the rate entered into (Distance per IPM MPM). This is really a distance based on the following calculation: For every 1 IPM or MPM of F code, start the slow down at the distance of (Distance per IPM/MPM) multiplied by F. Example: 0.500=0.001*F500. The (DecelStop at End of Move) box forces a decelerated stop at the end of the current line being cut. The (Smooth lines that consecutively have moves smaller than first angle) box will insert a G8 and G9 smooth spline mode into the program whenever line-to-line cuts are being made that consecutively have included angles less than the value entered into the first box (When angle of next move is greater than). A new feedrate will only be generated when the included angle on the next move is greater than the value in the first box and less than the second box and so on. The user must be sure to cover all included angle possibilities. If the included angle is greater than the value in the last box, no feedrate change will take place.

(When Cutting a Line and Next Move is a Radius or Fillet)

This group of settings only goes into effect when the current move is a line and the next move is an arc, circle or fillet. The (Use percentage method vs. forced) box allows the user to toggle between two alternate feedrate calculation methods. The percentage method multiplies the original programmed feedrate by the percentage value the user entered into the (% method of maximum cutting feedrate) box whenever the radius of the next move falls between the boxes labeled (When radius of next move is less than). Always enter the radius sizes from smallest to largest, from left to right, into the (When radius of next move is less than) boxes. The (Forced feed method for maximum cutting feedrate) method inserts a predetermined feedrate instead of calculating the feedrate based on percentage. Setting the (% method of maximum cutting feedrate), (Distance per IPM/MPM) or (Forced feed method for maximum cutting feedrate) boxes to 0 disables these features. The distance at which the slow down occurs is at the rate entered into the (Distance per IPM/MPM) box. This is really a distance based on the calculation: For every 1 IPM or MPM of F code start the slow down at the distance of (Distance per IPM/MPM) multiplied by F. Example: 0.500=0.001*F500. The (DecelStop always) box forces a decelerated stop at the end of the current line being cut. The (Only DecelStop on Non Tangent arcs) only forces a decel stop when the line and next arc are not tangent to each other. A new feedrate will be calculated whenever the radius on the next move is greater than zero to the value in the first box and then between the first and second box and so on. The user must be sure to cover all radius size possibilities. If the radius size is greater than the value in the last box, no feedrate change will take place.

(When Cutting a Radius or Fillet)

This group of settings only goes into effect when the current move is an arc, circle or fillet and there is a move of any type in the next G code line. The (Use percentage method vs. forced) box allows the user to toggle between two alternate feedrate calculation methods. The percentage method multiplies the original programmed feedrate by the percentage value the user entered into the (% method of maximum cutting feedrate) box whenever the current radius size falls between the boxes labeled (At radius size of). Always enter the radius sizes from smallest to largest, from left to right, into the (When radius of next move is less than) boxes. The (Forced feedrate method) box inserts a predetermined feedrate instead of calculating the feedrate based on percentage. Setting the (% of original velocity) or (Forced feedrate method) boxes to 0 disables these features. The (DecelStop on Non Tangent arcs only) box only forces a decel stop when the next move is not tangent to the current arc. A new feedrate will be calculated whenever the current radius is greater than zero in the value in the first box and then between the first and second box and so on. The user must be sure to cover all radius size possibilities. If the radius size is greater than the value in the last box, no feedrate change will take place.

(Fix Feedrate Upon Encounter with)

If the user desires to force a feedrate whenever a certain G code is executed, then the user would fill in the blanks on (If G code is xxx force feedrate of xxx). This may be useful if a certain canned cycle is encountered. A value of zero in the G code box disables that feature. The (Use these G code features) box will disable the whole group.

(Fix Feedrate upon Encounter with Tool Number)

If the user desires to force a feedrate whenever a certain T code is executed, then the user would fill in the blanks on (T xxx Fix F of). This may be useful if a certain tool number is encountered. A value of zero in the T code box disables that feature. The (Use tool features) box will disable the whole group.

What is claimed is:

1. SmartPath is a complete intelligent tool path optimizer.

2. SmartPath automatically gathers feedback from the CNC machine tool controller.

3. SmartPath bases its optimization on spindle torque and stresses.

4. SmartPath automatically sets acceleration, deceleration and velocity.

5. SmartPath allows users to override data collected and also override cutting conditions and methods.

6. SmartPath is an intelligent post processor that has been in use since 1991.

7. I, Gary John Corey, solely invented this technology based on research I conducted as a CNC machinist.

8. SmartPath is unique because it is directly connected to and is part of the CNC machine tool controller itself automatically sensing all factors and feedback in real time as the machine cuts and decides what method to cut the part.
